(19) United States
(12) Patent Application Publication
(10) Pub. No.: US 2012/0017735 A1
(43) Pub. Date: Jan. 26, 2012

(54) CUTTING TOOLS HAVING MOVABLE COVER MOUNTING STRUCTURES

(75) Inventors: Masahiko INAI, Anjo-shi (JP); Toshiyuki KANI, Anjo-shi (JP); Syuji AOYAMA, Anjo-shi (JP); Shinichiro TOMITA, Anjo-shi (JP)

(73) Assignee: MAKITA CORPORATION, ANJO-SHI (JP)

(21) Appl. No.: 13/187,048

(22) Filed: Jul. 20, 2011

(30) Foreign Application Priority Data
Jul. 22, 2010 (JP) 2010-164999

(51) Int. Cl. B27G 19/02; B27G 3/00; B26D 7/18

(52) U.S. Cl. 83/166; 83/860

(57) ABSTRACT

A cutting tool includes a tool unit having a rotary cutting blade, a movable cover configured to cover the rotary cutting blade, and a rotary support member mounted to the tool unit and rotatably supporting the movable cover about a rotational axis. The rotary support member and the movable cover has contact surfaces that slidably contact with each other or slidably contact with contact surface of an intermediate member interposed between the rotary support member and the movable cover. At least one of the contact surfaces includes a groove formed therein, so that the groove can receive cutting powder or chips produced by the rotary cutting blade during a cutting operation and entering between the movable cover and the rotary support member.

This application claims priority to Japanese patent application serial number 2010-164999, the contents of which are incorporated herein by reference.

### BACKGROUND OF THE INVENTION

1. Field of the Invention

The present invention relates to cutting tools having a mounting structure for a movable covers covering a rotary cutting blade that can cut a workpiece.

2. Description of the Related Art

Cutting tools so-called circular saws, such as a hand-held circular saw, a table circular saw, a slide circular saw, etc., are known. This type of cutting tools generally includes a circular rotary cutting blade driven by an electric motor as a power source. The rotary cutting blade has a cutting edge or an abrasive edge at the circumference of a circular shape, and the circumference of the rotary cutting blade is applied to a workpiece for cutting or abrading the workpiece. In order to cover the rotary cutting blade along its circumferential direction, there are provided a fixed cover and a movable cover. The fixed cover is generally called as a blade case, and the movable cover is generally called as a safety cover.

Because the rotary cutting blade cuts the workpiece as it rotates, cutting powder or chips may be blown upward from a cut portion of the workpiece by the rotation of the rotary cutting blade. The fixed cover and the movable cover can prevent the cutting powder or chips from being scattered to the surrounding after being blown upward. The movable cover is normally rotatably supported on a cutting unit that rotatably supports the rotary cutting blade. The cutting unit includes a rotary support mechanism for rotatably supporting a spindle that rotates the rotary cutting blade. In general, the outer peripheral portion of the rotary support mechanism rotatably supports the movable cover.

The peripheral edge of a rotary support hole formed in the movable cover slidably contacts the outer peripheral portion of the rotary support mechanism, so that the movable cover can mate relative to the cutting unit in a stable manner. In this way, the rotation of the movable cover relative to the cutting unit is performed under the guide of a slide contact portion of the outer peripheral portion of the rotary support mechanism, which slidably contacts the peripheral edge of the rotary support hole of the movable cover. This support structure is disclosed, for example, in U.S. Pat. No. 6,739,060.

However, in some cases, the cutting powder or chips blown up from the cut portion may reach the slide contact portion. Therefore, it is necessary to enable smooth rotation of the movable cover relative to the cutting unit even in the case that the cut powder (or chips) has entered the slide contact portion. To achieve this, it is necessary to highly accurately perform the dimensional control and the process management of the slide contact portion. However, if the dimensional control and the process management are performed highly accurately, a heavy burden is necessary to be born in terms of the manufacturing management.

Therefore, there is a need in the art for cutting tools having a mounting structure for a movable cover, which can reduce the burden in terms of the manufacturing management.

### SUMMARY OF THE INVENTION

According to the present teaching, a cutting tool includes a tool unit having a rotary cutting blade, a movable cover configured to cover the rotary cutting blade, and a rotary support member mounted to the tool unit and rotatably supporting the movable cover about a rotational axis. The rotary support member and the movable cover have contact surfaces that slidably contact with each other or slidably contact with contact surfaces of an intermediate member interposed between the rotary support member and the movable cover. At least one of the contact surfaces includes a groove formed therein, so that the groove can receive cutting powder or chips produced by the rotary cutting blade during a cutting operation and entering between the movable cover and the rotary support member.

### BRIEF DESCRIPTION OF THE DRAWINGS

FIG. 1 is a sectional view showing an internal structure of a cutting tool configured as a circular saw according to a first example;

FIG. 2 is an enlarged sectional view of a rotary support structure for a safety cover of the cutting tool;

FIG. 3 is a front view of a slide contact portion of the safety cover;

FIG. 4 is a sectional view taken along line IV-IV in FIG. 3;

FIG. 5 is a front view of a slide contact portion of the safety cover according to a second example;

FIG. 6 is a sectional view taken along line VI-VI in FIG. 5;

FIG. 7 is a front view of a slide contact portion of a safety cover according to a third example;

FIG. 8 is a sectional view taken along line VIII-VIII in FIG. 7;

FIG. 9 is a front view of a slide contact portion of the safety cover according to a fourth example;

FIG. 10 is a sectional view taken along line X-X in FIG. 9;

FIG. 11 is a front view of a bearing box showing a slide contact portion of a tubular support portion according to a fifth example;

FIG. 12 is a sectional view taken along line XII-XII in FIG. 11;

FIG. 13 is a front view of a bearing box showing a slide contact portion of a tubular support portion according to a sixth example;

FIG. 14 is a sectional view taken along line XIV-XIV in FIG. 13;

FIG. 15 is a front view of a bearing box showing a slide contact portion of a tubular support portion according to a seventh example;

FIG. 16 is a sectional view taken along line XVI-XVI in FIG. 15;

FIG. 17 is a front view of a bearing box showing a slide contact portion of a tubular support portion according to an eighth example;

FIG. 18 is a sectional view taken along line XVIII-XVIII in FIG. 17;

FIG. 19 is an enlarged sectional view of a rotary support structure for a safety cover of a cutting tool according to a ninth example;

FIG. 20 is a front view of an intermediate member configured as a slide ring shown in FIG. 19;

FIG. 21 is a sectional view taken along line XXI-XXI in FIG. 20;

FIG. 22 is a side view of the slide ring as viewed in a direction indicated by arrows XXII in FIG. 21;

FIG. 23 shows a perspective view of a movable cover according to another example; and

FIG. 24 is a sectional view taken along line XXIV-XXIV in FIG. 23.

### DETAILED DESCRIPTION OF THE INVENTION

Each of the additional features and teachings disclosed above and below may be utilized separately or in conjunction with other features and teachings to provide improved movable cover mounting structures and cutting tools having such improved mounting structures. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one example, a cutting tool includes a tool unit having a rotary cutting blade, a movable cover configured to cover the rotary cg blade, and a rotary support member mounted to the tool unit and rotatably supporting the movable cover about a rotational axis. The rotary support member has a first contact surface. The movable cover has a second contact surface slidably contacting the first contact surface, so that the first contact surface and the second contact surface slide relative to each other in a circumferential direction about the rotational axis as the movable cover rotates relative to the rotary support member. At least one of the first and second contact surfaces has a groove formed therein.

Therefore, cutting powder or chips produced by the rotary cutting blade during a cutting operation and entering between the rotary support member and the movable cover may enter the groove formed in at least one of the first and second contact surfaces. Hence, it is possible to avoid the situation where the sliding contact between the first and second contact surfaces is impaired by the cutting powder or chips. As a result it is possible to ensure a smooth slide contact performance. In addition, it is possible to reduce the burden required for the dimensional control and the process management for the first and second slide contact surfaces and to eventually reduce the burden required for the manufacturing management. Thus, it is possible to ensure a smooth slide contact performance while enabling reduction in the accuracy required in the dimensional control and the process management. Consequently, it is possible to reduce the burden required for the manufacturing management.

In addition, according to the above arrangement, the movable cover directly contacts the rotary support member via the first and second contact surfaces, and the groove is formed in at least one of the first and second contact surfaces. Therefore, it is possible to apply this improvement to an existing movable cover mounting structure having slide contact surfaces by simply forming the groove in at least one of the slide contact surfaces. Thus, because the existing mounting structure can be used the manufacturing cost can be reduced.

In another example, an intermediate member is interposed between the rotary support member and the movable cover. The intermediate member has a third contact surface and a fourth contact surface slidably contacting the first contact surface and the second contact surface, respectively, so that the first and third contact surfaces slide relative to each other in a circumferential direction about the rotational axis and/or the second and fourth contact surfaces slide relative to each other in the circumferential direction as the movable cover rotates relative to the rotary support member. In this example, the groove is formed in at least one of the first, second, third and fourth surfaces.

With this arrangement, by forming the groove in the intermediate member, it is possible to effectively adjust the slidability of the movable cover relative to the rotary support member. In addition, the groove can be easily formed in the intermediate member.

The groove may extend in a direction intersecting with the circumferential direction or the sliding direction. With this arrangement, cutting powder or chips moving in the circumferential direction according to the rotation of the movable cover relative to the rotary support member can smoothly enter the groove. Therefore, it is possible to ensure the sliding performance of the slide contact surfaces.

The direction intersecting with the circumferential direction may be parallel to the rotational axis or may be inclined relative to the rotational axis.

The groove may have opposite ends positioned on opposite sides with respect to a direction along the rotational axis and at least one of the opposite ends may be opened to the outside in an axial direction of the rotational axis. With this arrangement, cutting powder or chips entering the groove can be discharged to the outside. Therefore, even in the case that cutting powder (or chips) has been filled up within the groove, the cutting powder can be smoothly discharged to the outside of the groove. As a result, the function of the groove for receiving and discharging the cutting powder can be effectively maintained.

The groove may have a width in the circumferential direction about the rotational axis and may have a length in the direction parallel to the rotational axis. The width may gradually increase in a direction from one of the opposite ends to the other of the opposite ends or may gradually increase from an intermediate portion along the length to the opposite ends.

The groove may include a plurality of grooves spaced from each other in the circumferential direction about the rotational axis. Alternatively, the groove may be a spiral groove.

Various examples will now be described with reference to the drawings.

### FIRST TO FOURTH EXAMPLES

### First Example

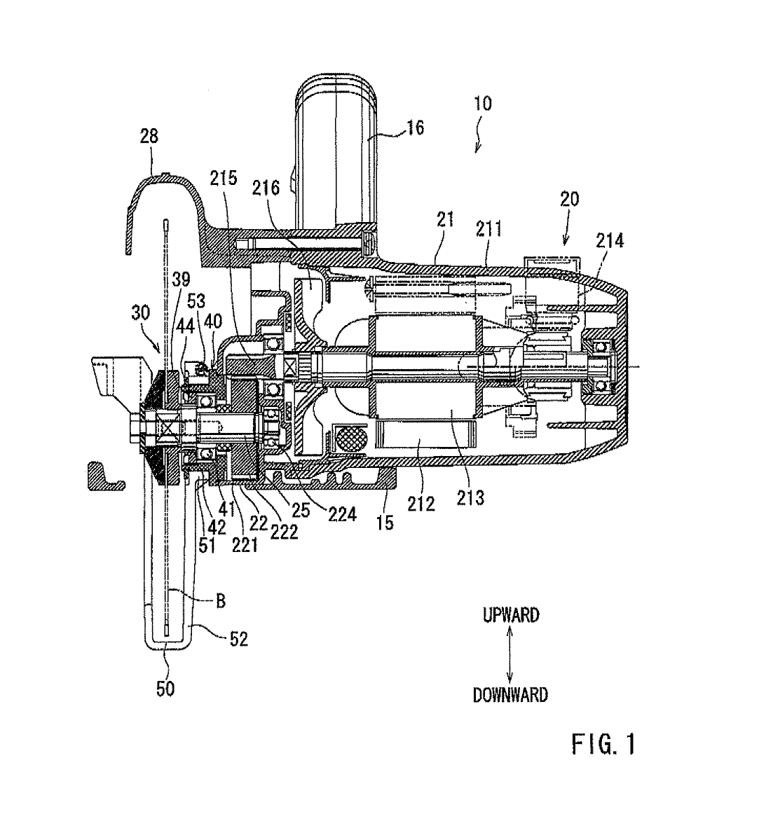

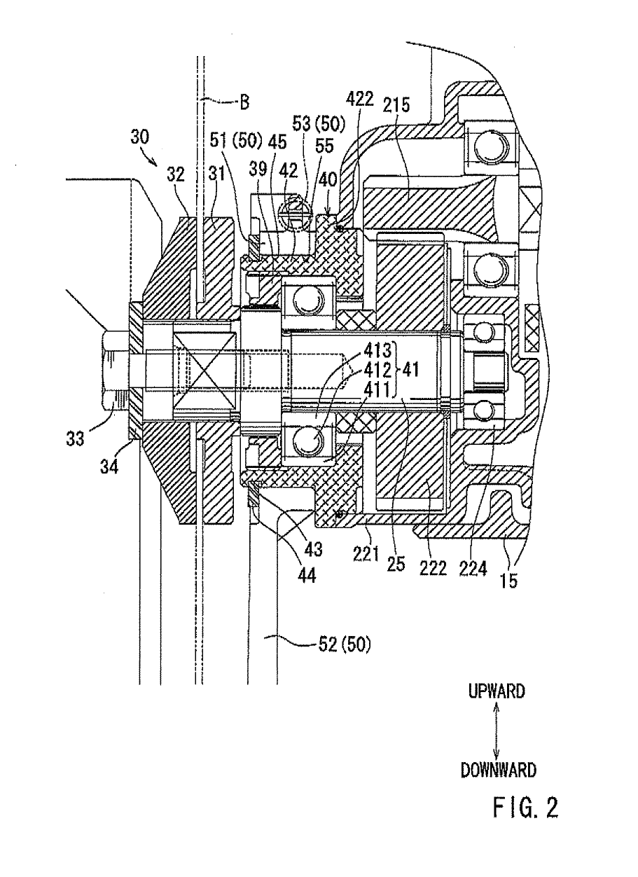

Referring to FIGS. 1 to 4, there is shown a hand-held cutting tool 10 according to a first example. FIG. 1 shows a sectional view showing an internal structure of the cutting tool 10. FIG. 2 is an enlarged view of a rotary support structure for a safety cover 50 show in FIG. 1. In the following explanation, the left side of the cutting tool 10 as viewed in FIG. 1, where a rotary cutting blade B is positioned, will be referred to as a right side, whereas the right side of the cutting tool 10 as viewed in FIG. 1 or the side opposite to the rotary cutting blade B will be referred to as a left side. Further, the lower side of the cutting tool 10 as viewed in FIG. 1, where a base 15 is positioned, will be referred to as a lower side, whereas the upper side of the cutting tool 10 as viewed in FIG. 1 or the side opposite to the base 15 will be referred to as an upper side. The cutting tool 10 is configured to machine a workpiece by applying to the workpiece the outer circumference with respect to the circular configuration of the rotary cutting blade B. In this example, the rotary cutting blade B is a circular saw blade. However, the rotary cutting blade B may be that having a cutting edge at its outer circumference or may be a whetstone for abrading the workplace.

The cutting tool 10 generally includes a cutting unit 20, a blade case 28 and a safety cover 50. The cutting unit 20 has a spindle 25 that rotatably drives the rotary cutting blade B. The blade case 28 and the safety cover 50 are disposed to cover the rotary cutting blade B.

The cutting unit 20 will now be described. As shown in FIG. 1, the cutting unit 20 includes a drive device 21 for producing a rotary driving force, a speed-change device 22 for changing the rotational speed of the drive device 21, and the spindle 25 serving as an output shaft of the rotation of the drive device 21 after the rotational speed has been changed by the speed-change device 22.

The drive device 21 generally includes a motor housing 211, a stator 212, a rotor 213 and a contact brush 214, so that the rotor 213 rotates when an electric power is supplied from an external power source (not shown). On the left side portion of the rotor 213, an output gear 215 is mounted so as to rotate with the rotor 213. The output gear 215 engages a reduction gear 222 of the speed-change device 22 as will be explained later. An air-blowing fan 216 is also mounted to the left side portion of the rotor 213 so as to rotate with the rotor 213. The air-blowing fan 216 serves as a blower. Therefore, as the fan 216 rotates, it draws cutting powder or chips that may be produced during a cutting operation of a workpiece by the rotary cutting blade B and may be blown upward.

The base 15 is positioned on the lower side of the drive device 21. The base 15 serves as a seat for seating on the workpiece when the cutting tool 10 is placed on the workpiece. On the other hand, a handle 16 is positioned on the upper side of the drive device 21 and can be grasped by a hand of an operator who operates the cutting tool 10. An operation switch (not shown) is disposed at the handle 16 for starting and stopping the drive device 21.

The speed-change device 22 generally includes a gear housing 221, the reduction gear 222 engaging the output gear 215 as described previously, and the spindle 25 that rotates with the reduction gear 222. The spindle 25 serves as a rotational shaft of the reduction gear 22 that is rotated by the rotation of the output gear 215 through engagement therewith. Therefore, the spindle 25 rotates with the reduction gear 222.

As shown in FIG. 2, the spindle 25 serves as an output shaft for rotating the rotary cutting blade B. The right side portion of the spindle 25 is rotatably supported by a bearing 224 disposed within the gear housing 221. On the other hand, the left side portion of the spindle 25 is rotatably supported by a bearing box 40 that will be explained later. Here, the left side portion of the spindle 25 is configured to be able to mount the rotary cutting blade B. To this end, the left side portion of the spindle 25 extends outwardly beyond the bearing box 40, and a blade holding mechanism 30 is provided on the outwardly extending part of the lefts side portion of the spindle 25. The blade holding mechanism 30 includes a first flange 31 and a second flange 32 for holding the rotary cutting blade B therebetween. The blade holding mechanism 30 further includes a bolt 33 and a washer 34 for mounting the first and second flanges 31 and 32 to the spindle 25. Therefore, a thread hole is formed in the spindle 25 to extend along the rotational axis of the spindle 25 for engagement with a male thread of the bolt 33. A portion of the outer surface of the spindle 25, where the first and second flanges 31 and 32 are mounted, is flattened so as to have a non-circular cross sectional configuration in this connection, the inner circumferential surfaces of the first and second flanges 31 and 32 are configured to conform to the non-circular cross sectional configuration of the flattened portion of the spindle 25, so that the first and second flanges 31 and 32 rotate together with the spindle 25.

The first and second flanges 31 and 32 are fastened to the spindle 25 by using the bolt 33 and the washer 34. Therefore, the rotary cutting blade B can be held between the first and second flanges 31 and 32 and can rotate with the spindle 25.

As shown in FIG. 1, the blade case 28 and the safety cover 50 serve to cover the rotary cutting blade B. More specifically, the blade case 28 is a fixed cover and is formed integrally with the motor housing 211 of the drive device 21. As shown in FIG. 1, the blade case 28 is positioned to cover the rotary cutting blade B from the upper side (where the handle 16 of the drive device 21, which is a part of the cutting unit 20, is positioned) and also from the left side with respect to the drive device 21. Unlike the safety cover 50 that will be explained later, the blade case 28 does not rotate relative to the cutting unit 20 but is fixed in position relative to the cutting unit 20 for covering the upper portion of the rotary cutting blade B.

The safety cover 50 is a movable cover and is movable to cover and uncover the lower portion of the rotary cutting blade B. The safety cover 50 is different from the blade case 28 in that it is rotatably movable relative to the cutting unit 20.

The safety cover 50 generally includes a tubular fitting portion 51, a cover body 52 and a coil spring 53. Here, the tubular fitting portion 51 and the cover body 52 are made of resin and molded integrally with each other. Therefore, the tubular fitting portion 51 and the cover body 52 are shaped to have given configurations when they are molded.

As will be explained later, the tubular fitting portion 51 is slidably fitted on an outer case 42 of the bearing box 42. The cover body 52 is configured to be able to cover the lower portion of the rotary cutting blade B. One end of the coil spring 53 is connected to the outer circumferential part of the tubular fitting portion 51, while the other end of the coil spring 53 is connected to the inner circumferential wall (not shown) of the blade case 28. With this arrangement, the coil spring 53 normally biases the cover body 52 in such a direction that the lower portion of the cover body 52 moves toward the front side of the sheet of FIG. 1.

The mounting structure of the safety cove 50 will now be described in detail. As described above, the safety cover 50 is supported by the cutting unit 20 via the bearing box 40 so as to be rotatable relative to the cutting unit 20. Thus, the bearing box 40 serves as a rotary support member for rotatably supporting the safety cover 50. Because the bearing box 40 is fixed in position relative to the gear housing 221, the bearing box 40 is fixedly mounted to the cutting unit 20 including the speed-change device 22.

The bearing box 40 includes a bearing body 41, the outer case 42 and a bearing retainer 39. The bearing body 41 is configured as a ball bearing and has an outer race 411, an inner race 413 and a plurality of bearing balls 412 interposed between the outer and inner races 411 and 413. The bearing retainer 39 is positioned on the left side of the bearing body 41 and serves to prevent the bearing body 41 from moving in a thrust direction.

The outer case 42 receives therein the bearing body 41. The outer case 42 has a substantially cylindrical tubular configuration and has an outer flange 422 at its right end (see FIG. 2). The intermediate portion of the outer case 42 on the left side of the outer flange 422 has a smooth cylindrical outer surface. A ring-shaped groove 43 is formed in the left end of the outer case 42 for fitting with a circlip (stop ring) 44. As will be explained later, the tubular fitting portion 51 of the safety cover 50 is slidably fitted on the intermediate portion of the outer case 42. By fitting the circlip 44 into the ring-shaped groove 43 at the left end of the outer case 42 in the state that the tubular fitting portion 51 is fitted on the intermediate portion of the outer case 42, it is possible to prevent the tubular fitting portion 51 from being removed from the intermediate portion of the outer case 42.

The slide contact structure of the tubular fitting portion 51 of the safety cover 50 relative to the outer case 42 of the bearing box 40 will now be described. In this example, the slide contact structure includes an outer circumferential surface 45 of the outer case 42 and an inner circumferential surface 55 of the tubular fitting portion 51, which slidably contact with each other to allow rotation of the tubular fitting portion 51 relative to the outer case 42. Thus, in this mounting structure of the safety cover 50, no intermediate member is provided between the outer case 42 of the bearing box 40 and the tubular fitting portion 51 of the safety cover 50, but the tubular fitting portion 51 directly slidably contacts the outer case 42.

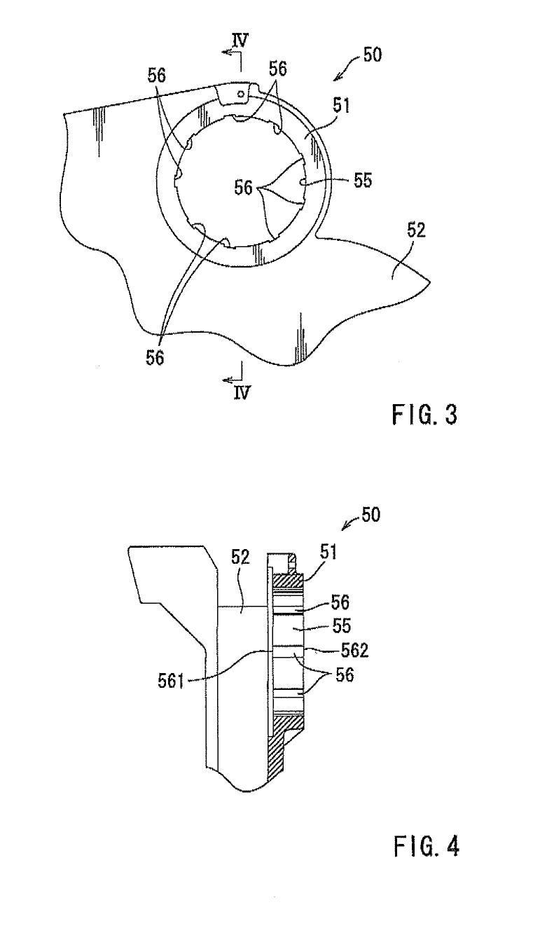

In the mounting structure of the safety cover 50 of this example, a plurality of grooves 56 are formed in the inner circumferential surface 55 of the tubular fitting portion 51 as shown in FIGS. 3 and 4. As shown in FIG. 3, nine grooves 56 are formed in the inner circumferential surface 55 and are spaced equally from each other in the circumferential direction. As shown in FIG. 4, the grooves 56 extend parallel to each other in the axial direction of the rotational axis of the tubular fitting portion 51. In other words, each of the grooves 56 extends in a direction substantially perpendicularly intersecting with the sliding direction of the inner circumferential surface 55 of the tubular fitting portion 51 (i.e., the circumferential direction about the rotational axis of the tubular fitting portion 51). Each of the grooves 56 is opened on the side facing to the outer circumferential surface 45 of the outer case 42 and has opposite ends 561 and 562 in a direction parallel to the rotational axis of the tubular fitting portion 51 or the direction perpendicularly intersecting with the sliding direction (circumferential direction) of the inner circumferential surface 55. The opposite ends 561 and 562 are opened to the outside in an axial direction of the rotational axis, so that each of the grooves 56 communicates with the outside.

Cutting powder or chips may enter between the outer circumferential surface 45 of the outer case 42 and the inner circumferential surface 55 of the tubular fitting portion 51, which serve as slide contact surfaces. However, as these surfaces slide relative to each other, cutting powder or chips may move into the grooves 56, so that the grooves 56 serve to receive the cutting powder or chips. Therefore, the width and the depth of the grooves 56 are so determined as to be suitable for receiving the cutting powder or chips. However, it is necessary to ensure that the tubular fitting portion 51 smoothly rotates relative to the outer case 42 without causing substantial movement in the radial direction. Therefore, slide contact areas, in particular their circumferential lengths, of the outer circumferential surface 45 and the inner circumferential surface 55 are necessary to be sufficient. For this reason, in this example, the grooves 56 are spaced equally from each other in the circumferential direction and the width of the grooves 56 are set not to impair the smooth rotation of the tubular fitting portion 51.

According to the mounting structure of the safety cover 50 of the above example, the grooves 56 are formed in the inner circumferential surface 55 of the tubular fitting portion 51, which serves one of slide contact surfaces for the sliding rotation of the safety cover 50 relative to the bearing box 40. Therefore, the cutting powder or chips entering between the outer circumferential surface 45 and the inner circumferential surface 55 may move into the grooves 56 as the outer circumferential surface 45 and the inner circumferential surface 55 move to slide relative to each other. Hence, it is possible to avoid the situation where the sliding contact between the outer circumferential surface 45 and the inner circumferential surface 55 is impaired by the cutting powder or chips. As a result it is possible to ensure a smooth slide contact performance at the contact portions. In addition, because the smooth slide contact performance can be ensured by providing the grooves 56, it is possible to reduce the burden required for the dimensional control and the process management for the slide contact surfaces and to eventually reduce the burden required for the manufacturing management. Thus, according to the mounting structure of the safety cover 50 of this example, it is possible to ensure a smooth slide contact performance of the slide contact portions while enabling reduction in the accuracy required in the dimensional control and the process management. Consequently, it is possible to reduce the burden required for the manufacturing management.

Further, according to the mounting structure of the safety cover 50 of the above example, the safety cover 50 directly slidably contacts the bearing box 40, and the grooves 56 are formed in the inner circumferential surface 55 of the tubular fitting portion 51, which serves as one of slide contact surfaces. Therefore, it is possible to apply this improvement to an existing mounting structure having slide contact surfaces by simply forming the grooves 56 in one of the slide contact surface. Thus, because the existing mounting structure can be used the manufacturing cost can be reduced.

Furthermore, according to the mounting structure of the safety cover 50 of the above example, the grooves 56 extend in directions intersecting with the sliding direction of the inner circumferential surface 55 (i.e., the circumferential direction). Therefore, cutting powder or chips entering between the outer circumferential surface 45 and the inner circumferential surface 55 can smoothly enter the grooves 56 as the outer circumferential surface 45 and the inner circumferential surface 55 move to slide relative to each other. As a result, it is possible to further reliably ensure the slide contact performance of the slide contact portions.

Furthermore, according to the mounting structure of the safety cover 50 of the above example, the opposite ends 561 and 562 of each groove 56 are opened to the outside, so that cutting powder or chips can be discharged to the outside. Therefore, it is possible to always maintain the function of ensuring the smooth slide contact performance given by the grooves 56.

### Second Example

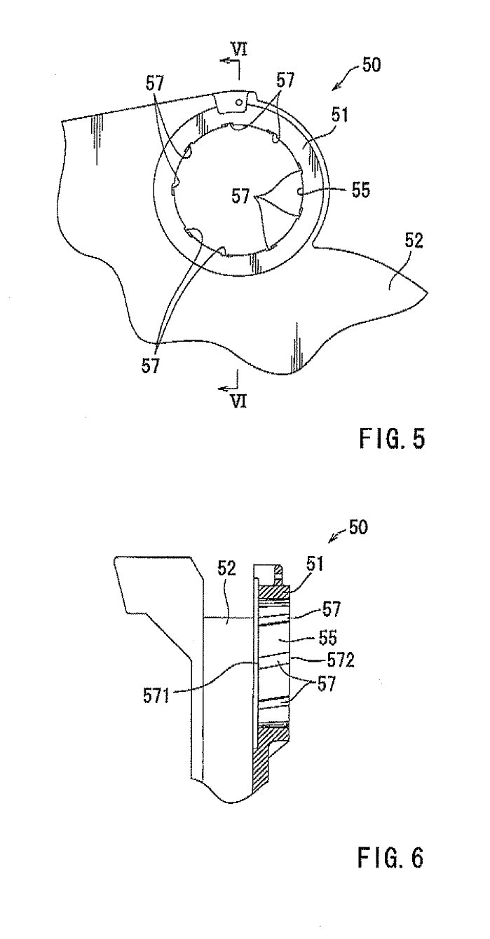

A second example will now be described with reference to FIGS. 5 and 6, which show a mounting structure for mounting the safety cover 50 of this example. The mounting structure of this example is different from that of the first example only in that grooves 57 having a different configuration from the grooves 56 are formed in the inner circumferential surface 55 of the tubular fitting portion 51. In other respect, the second example is the same as the first example. Therefore, in FIGS. 5 and 6, like members are given the same reference numerals as the first example and the description of these members will now be repeated.

Referring to FIG. 5, there is shown the grooves 57 formed in the inner circumferential surface 35, which serves as one of the slide contact surfaces, of the tubular fitting portion 51 of the safety cover 50. Similar to the grooves 56 of the first example, the number of the grooves 57 is nine, and the grooves 57 are spaced equally from each other in the circumferential direction of the inner circumferential surface 55 and extend parallel to each other in directions intersecting with the sliding direction of the inner circumferential surface 55 of the tubular fitting portion 51 (i.e., the circumferential direction) relative to the outer circumferential surface 45 of the outer case 42. However, unlike the grooves 56, each of the grooves 57 extends in a direction inclined relative to a direction perpendicularly intersecting with the sliding direction (i.e., the circumferential direction) of the inner circumferential surface 55 of the tubular fitting portion 51 and also inclined relative to the rotational axis of the tubular fitting portion 51. More specifically, as shown in FIG. 6, each of the grooves 57 is inclined downwardly from the side of the drive device 21 toward the side of the rotary cutting blade R as viewed in a horizontal side view

Similar to the grooves 56, each of the grooves 57 has opposite ends 571 and 572 that are opened to the outside. Therefore, as the tubular fitting portion 51 rotates relative to the outer case 42, cutting powder or chips entering between the outer circumferential surface 45 of the outer case 42 and the inner circumferential surface 55 of the tubular fitting portion 51 may move into the grooves 57 and then be discharged to the outside. Similar to the grooves 56, the width and the depth of the grooves 57 are so determined as to be suitable for receiving the cutting powder or chips. However, it is necessary to ensure that the tubular fitting portion 51 smoothly rotates relative to the outer case 42 without causing substantial movement in the radial direction. Therefore, also in this example, slide contact areas, in particular their circumferential lengths, of the outer circumferential surface 45 and the inner circumferential surface 55 are necessary to be sufficient. For this reason, the grooves 57 are spaced equally from each other in the circumferential direction and the width of the grooves 57 is set not to impair the smooth rotation of the tubular fitting portion 51.

According to the mounting structure of the safety cover 50 incorporating the grooves 57 of the second example, it is possible to achieve the same advantages, as the mounting structure incorporating the grooves 56 of the first example. In addition, cutting powder or chips entering into the grooves 57 according to the sliding movement relative to the outer circumferential surface 45 of the outer case 42 may move along the grooves 57 in the directions inclined relative to a direction perpendicularly intersecting with the sliding direction (i.e., the circumferential direction) and also inclined relative to the rotational axis of the tubular fitting portion 51. Therefore, the cutting powder or chips can more smoothly move along the grooves 57 before being discharged to the outside. Thus, due to the inclination of the grooves 57, the moving direction of cutting powder or chips entering the grooves 57 may be changed in the right or left direction, so the cutting powder can be effectively discharged to the outside from the grooves 57. Therefore, even in the case that cutting powder (or chips) has been filled up within the grooves 57, the cutting powder or chips can be smoothly discharged to the outside of the grooves 57. As a result, the function of the grooves 57 for receiving and discharging the cutting powder can be effectively maintained.

### Third Example

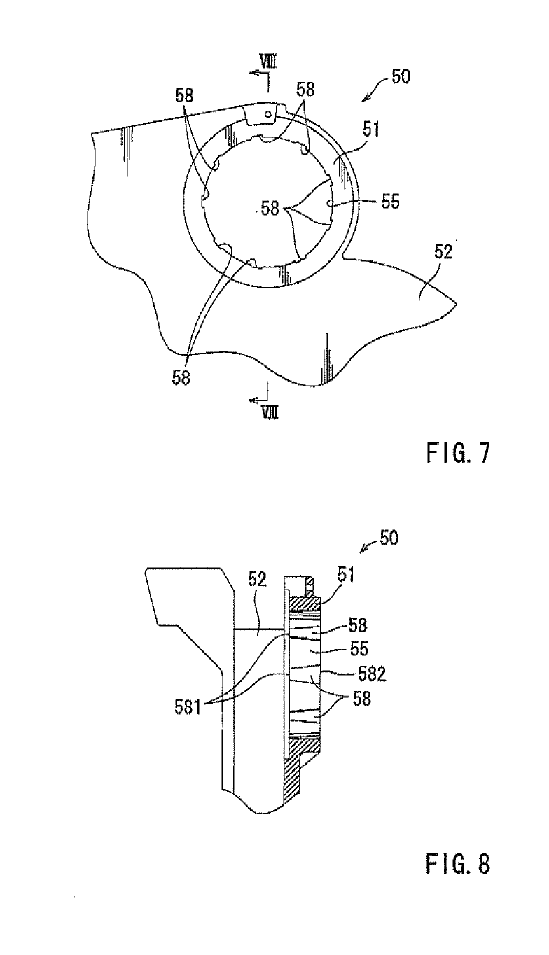

A third example will now be described with reference to FIGS. 7 and 8, which show a mounting structure for mounting the safety cover 50 of this example. The mounting structure according to the third example is different from the first example only in that grooves 58 having a different configuration from the grooves 56 are formed in the inner circumferential surface 55 of the tubular fitting portion 51. In other respect, the third example is the same as the first example. Therefore, in FIGS. 7 and 8, like members are given the same reference numerals as the first example and the description of these members will now be repeated.

Referring to FIG. 7, there is shown the grooves 58 formed in the inner circumferential surface 55, which serves as one of the slide contact surfaces, of the tubular fitting portion 51 of the safety cover 50. Similar to the grooves 56 of the first example, the number of the grooves 58 is nine, and the grooves 58 are spaced equally from each other in the circumferential direction of the inner circumferential surface 55 and extend in directions intersecting with the sliding direction of the inner circumferential surface 55 of the tubular fitting portion 51 (i.e., the circumferential direction) relative to the outer circumferential surface 45 of the outer case 42. However, unlike the grooves 56, each of the grooves 58 is configured to have a width that becomes gradually larger in a direction from the side of the rotary cutting blade B toward the drive device 21 as viewed in a horizontal side view as shown in FIG. 8. Therefore, each of the grooves 58 has a trapezoidal configuration enlarged toward the drive device 21.

Similar to the grooves 56, each of the grooves 58 has opposite ends 581 and 582 that are opened to the outside. Therefore, as the tubular fitting portion 51 rotates relative to the outer case 42, cutting powder or chips entering between the outer circumferential surface 45 of the outer case 42 and the inner circumferential surface 55 of the tubular fitting portion 51 may move into the grooves 58 and then be discharged to the outside. Similar to the grooves 56, the width and the depth of the grooves 58 are determined so as to be suitable for receiving the cutting powder or chips. However, it is necessary to ensure that the tubular fitting portion 51 smoothly rotates relative to the outer case 42 without causing substantial movement in the radial direction. Therefore, also in this example, slide contact areas, in particular their circumferential lengths, of the outer circumferential surface 45 and the inner circumferential surface 55 are necessary to be sufficient. For this reason, the grooves 58 are spaced equally from each other in the circumferential direction and the width of the grooves 58 is set not to impair the smooth rotation of the tubular fitting portion 51.

According to the mounting structure of the safety cover 50 incorporating the grooves 58 of the third example, it is possible to achieve the same advantages as the mounting structure incorporating the grooves 56 of the first example. In addition, cutting powder or chips entering into the grooves 58 according to the sliding movement relative to the outer circumferential surface 45 of the outer case 42 moves along the grooves 57 having the width enlarged toward the drive device 21. Therefore, the cutting powder or chips can more smoothly move along the grooves 58 before being discharged to the outside. Thus, due to the enlargement of the grooves 58 toward the drive device 21, the density of the cutting powder or chips may decreases as the cutting powder or chips moves toward the end 582. Therefore, even in the case that cutting powder or chips has been filled within the grooves 58, the cutting powder or chips can be smoothly discharged to the outside of the grooves 58. As a result, the function of the grooves 58 for receiving and discharging the cutting powder or chips can be effectively maintained.

### Fourth Example

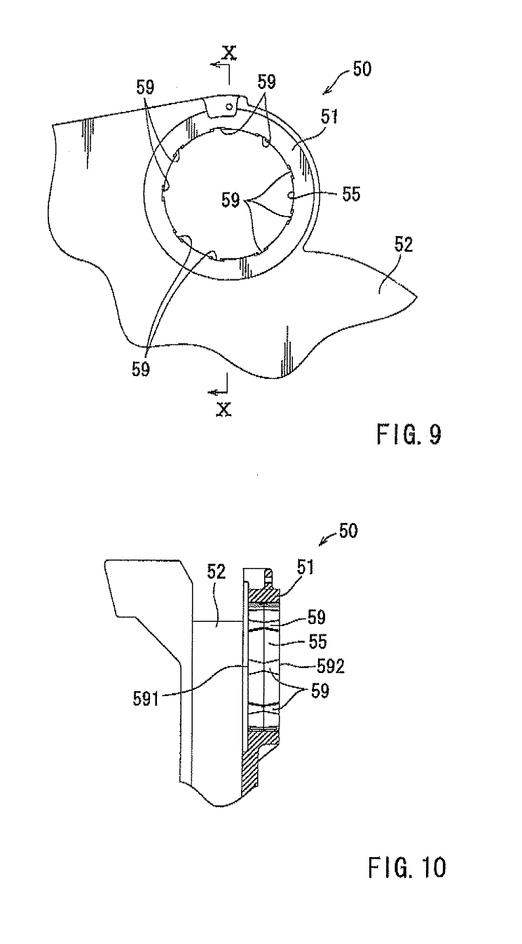

A fourth example will now be described with reference to FIGS. 9 and 10, which show a mounting structure for mounting the safety cover 50 of this example. Also, the mounting structure according to the fourth example is different from the first example only in that grooves 59 having a different configuration from the grooves 56 are formed in the inner circumferential surface 55 of the tubular fitting portion 51. In other respect, the fourth example is the same as the first example. Therefore, in FIGS. 9 and 10, like members are given the same reference numerals as the first example and the description of these members will now be repeated.

Referring to FIG. 9, there is shown the grooves 59 formed in the inner circumferential surface 55, which serves as one of the slide contact surfaces, of the tubular fitting portion 51 of the safety cover 50. Similar to the grooves 56 of the first example, the number of the grooves 59 is nine, and the grooves 59 are spaced equally from each other in the circumferential direction of the inner circumferential surface 55 and extend parallel to each other in directions intersecting with the sliding direction of the inner circumferential surface 55 of the tubular fitting portion 51 relative to the outer circumferential surface 45 of the outer case 42 (i.e., the circumferential direction). However, unlike the grooves 56, each of the grooves 59 has a minimum width at its intermediate portion along its length, so that the width becomes gradually larger from the intermediate portion toward the side of the rotary cutting blade 13 and also toward the side of the drive device 21. More specifically, the width of the groove 59 gradually increases from the intermediate portion to opposite ends 591 and 592 that are opened to the outside. Therefore, the groove 59 has a maximum width at the opposite ends 591 and 592.

Therefore, as the tubular fitting portion 51 rotates relative to the outer case 42, cutting powder or chips entering between the outer circumferential surface 45 of the outer case 42 and the inner circumferential surface 55 of the tubular fitting portion 51 may move into the grooves 59 and then be discharged to the outside. Similar to the grooves 56, the width (i.e. the minimum and maximum widths in this example) and the depth of the grooves 59 are so determined as to be suitable for receiving the cutting powder or chips. However, it is necessary to ensure that the tubular fitting portion 51 smoothly rotates relative to the outer case 42 without causing substantial movement in the radial direction. Therefore, also in this example, slide contact areas, in particular their circumferential lengths, of the outer circumferential surface 45 and the inner circumferential surface 55 are necessary to be sufficient. For this reason, the grooves 59 are spaced equally from each other in the circumferential direction and the width of the grooves 59 are set not to impair the smooth rotation of the tubular fitting portion 51.

According to the mounting structure of the safety cover 50 incorporating the grooves 59 of the fourth example, it is possible to achieve the same advantages as the mounting structure incorporating the grooves 56 of the first example. In addition, cutting powder or chips entering into the grooves 59 according to the sliding movement relative to the outer circumferential surface 45 of the outer case 42 moves along the grooves 59 that are enlarged toward the opposite ends 591 and 592. Therefore, the cutting powder or chips can more smoothly move along the grooves 59 before being discharged to the outside. In particular, due to the enlargement of the grooves 59 toward both of the rotary cutting blade B and the drive device 21, the density of the cutting powder or chips may decrease as the cutting powder or chips moves toward the opposite ends 591 and 592. Therefore, even in the case that cutting powder or chips has been filled within the grooves 59, the cutting powder or chips can be smoothly discharged to the outside of the grooves 59. As a result, the function of the grooves 59 for receiving and discharging the cutting powder can be effectively maintained.

### FIFTH TO EIGHTH EXAMPLES

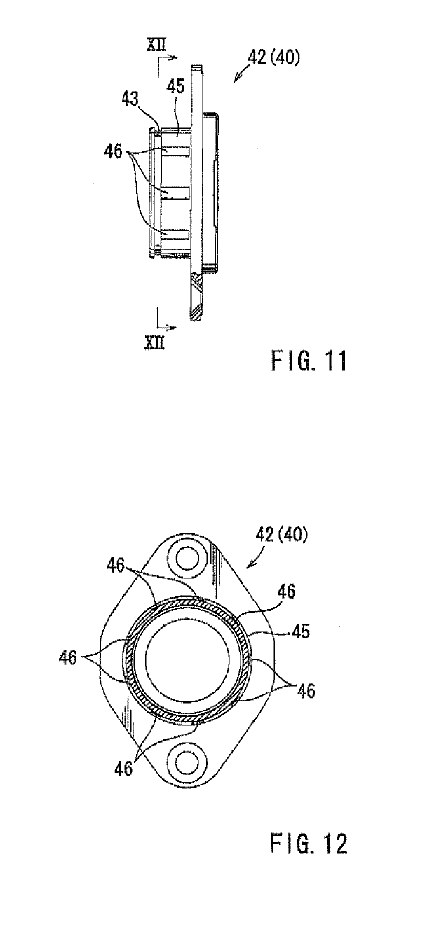

Fifth to eighth examples will now be described with reference to FIGS. 11 to 18, which show mounting structures for mounting the safety cover 50 of these examples.

The movable cover mounting structures of the fifth to eighth examples are similar to those of the first to fourth examples in that the outer circumferential surface 45 of the outer case 42 and the inner circumferential surface 55 of the tubular fitting portion 51 serves as slide contact surfaces that slide relative each other as the tubular fitting portion 51 rotates relative to the outer case 42. Also in the fifth to eighth examples, no intermediate member is provided between the outer case 42 of the bearing box 40 and the tubular fitting portion 51 of the safety cover 50, so that the tubular fitting portion 51 directly slidably contacts the outer case 42.

In the case of the mounting structures according to the first to fourth examples described above, the grooves 56, 57, 58 and 59 are formed in the inner circumferential surface 55 of the tubular fitting portion 51, which serves as one of the slide contact surfaces. However, in the case of the mounting structures of the fifth to eighth examples, grooves 46, 47, 48 and 49 are formed in the outer circumferential surface 45 of the outer case 42 in place of the grooves 56, 57, 58 and 59 of the first to fourth examples. In other respect, the fifth to eighth examples are the same as the first to fourth examples. Therefore, in FIGS. 11 to 18, like members are given the same reference numerals as the first to fourth examples, and the description of these members will not be repeated. The grooves 46, 47, 48 and 49 may be formed at the same time that the outer case 42 is formed, for example, by using a casting mold. Alternatively, a separate process performed after manufacturing the outer case 42 may form the grooves 46, 47, 48 and 49.

### Fifth Example

According to the mounting structure of the safety cover 50 of the fifth example, the grooves 56 described in the first example are not formed in the inner circumferential surface 55 of the tubular fitting portion 51 but are formed in the outer circumferential surface 45 of the outer case 42 as grooves 46. Thus, as shown in FIG. 11, nine grooves 46 are formed in the outer circumferential surface 45 of the outer case 42 and are spaced equally from each other. More specifically, each of the grooves 46 extends in a direction substantially perpendicularly intersecting with the sliding direction of the inner circumferential surface 55 of the tubular fitting portion 51 (i.e., the circumferential direction). Also, in this example, cutting powder or chips entering between the outer circumferential surface 45 of the outer case 42 and the inner circumferential surface 55 of the tubular fitting portion 51 may move into the grooves 46 as the tubular portion 51 rotates relative to the outer case 42. Also, similar to the first example, the width and the depth of the grooves 46 are so determined as to be suitable for receiving the cutting powder or chips and not to impair the smooth rotation of the tubular fitting portion 51.

According to the mounting structure of this example, it is possible to achieve the same advantages as the first example. In addition, because the grooves 46 are formed in the outer circumferential surface 45 of the outer case 42, the safety cover 50 is not necessary to change its design, and therefore, the safety cover 50 can be molded by using an existing molding die.

### Sixth Example

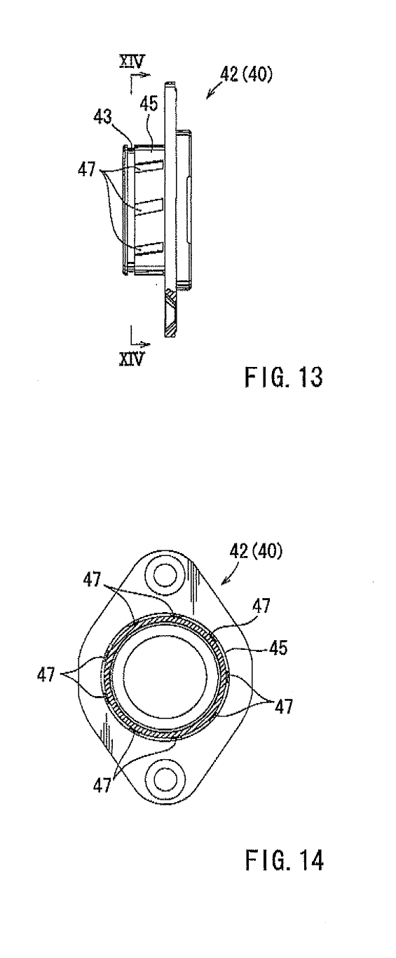

A movable cover mounting structure of a sixth example will now be described with reference to FIGS. 13 and 14. In this example, the grooves 57 described in the second example are not formed in the inner circumferential surface 55 of the tubular fitting portion 51 but are formed in the outer circumferential surface 45 of the outer case 42 as grooves 47. Thus, as shown in FIG. 11, nine grooves 47 are formed in the outer circumferential surface 45 of the outer case 42 and are spaced equally from each other. More specifically, similar to the grooves 57, each of the grooves 47 is inclined relative to a direction perpendicularly intersecting with the sliding direction (i.e., the circumferential direction) and also inclined relative to the rotational axis of the tubular fitting portion 51. Therefore, also in this example, cutting powder or chips entering between the outer circumferential surface 45 of the outer case 42 and the inner circumferential surface 55 of the tubular fitting portion 51 may move into the grooves 47 as the tubular portion 51 rotates relative to the outer case 42. In addition, the width and the depth of the grooves 47 are so determined as to be suitable for receiving the cutting powder or chips and not to impair the smooth rotation of the tubular fitting portion 51.

According to the mounting structure of this example, it is possible to achieve the same advantages as the second example. In addition, because the grooves 47 are formed in the outer circumferential surface 45 of the outer case 42, the safety cover 50 is not necessary to change its design, and therefore, the safety cover 50 can be molded by using an existing molding die.

### Seventh Example

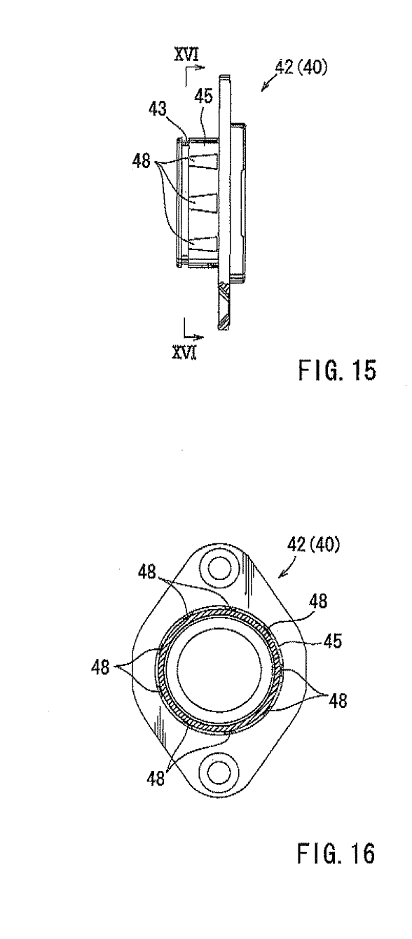

A movable cover mounting structure according to a seventh example will now be described with reference to FIGS. 15 and 16. In this example, the grooves 58 described in the third example are not formed in the inner circumferential surface 55 of the tubular fitting portion 51 but are formed in the outer circumferential surface 45 of the outer case 42 as grooves 48. Thus, as shown in FIG. 16, nine grooves 48 are formed in the outer circumferential surface 45 of the outer case 42 and are spaced equally from each other. Mare specifically, similar to the groove 58 of the third example, the number of the grooves 48 is nine, and the grooves 48 are spaced equally from each other in the circumferential direction. In addition, each of the grooves 48 is configured to have a width that becomes gradually larger in a direction from the side of the rotary cutting blade B toward the drive device 21 as viewed in a horizontal side view. Also, in this example, cutting powder or chips entering between the outer circumferential surface 45 of the outer case 42 and the inner circumferential surface 55 of the tubular fitting portion 51 may move into the grooves 48 as the tubular portion 51 rotates relative to the outer case 42. In addition, the width and the depth of the grooves 48 are so determined as to be suitable for receiving the cutting powder or chips and not to impair the smooth rotation of the tubular fitting portion 51.

According to the mounting structure of this example, it is possible to achieve the same advantages as the third example. In addition, because the grooves 48 are formed in the outer circumferential surface 45 of the outer case 42, the safety cover 50 is not necessary to change its design, and therefore, the safety cover 50 can be molded by using an existing molding die.

### Eighth Example

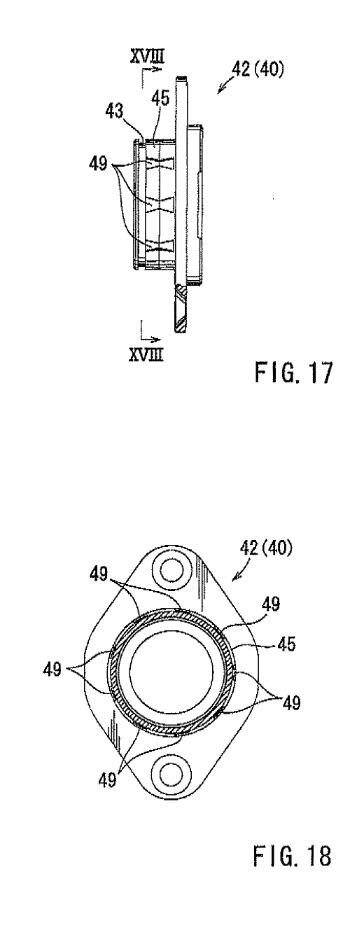

A movable cover mounting structure according to an eighth example will now be described with reference to FIGS. 17 and 18. In this example, the grooves 59 described in the fourth example are not formed in the inner circumferential surface 55 of the tubular fitting portion 51 but are formed in the outer circumferential surface 45 of the outer case 42 as grooves 49. Thus, as shown in FIG. 18, nine grooves 49 are formed in the outer circumferential surface 45 of the outer case 42 and are spaced equally from each other. More specifically, similar to the groove 59 of the third example, the number of the grooves 49 is nine, and the grooves 49 are spaced equally from each other in the circumferential direction. In addition, each of the grooves 49 has a minimum width at its intermediate portion along its length, so that the width becomes larger from the intermediate portion toward the side of the rotary cutting blade B and also toward the side of the drive device 21. Also, in this example, cutting powder or chips entering between the outer circumferential surface 45 of the outer case 42 and the inner circumferential surface 55 of the tubular fitting portion 51 may move into the grooves 49 as the tubular portion 51 rotates relative to the outer case 42. In addition, the width and the depth of the grooves 49 are so determined as to be suitable for receiving the cutting powder or chips and not to impair the smooth rotation of the tubular fitting portion 51.

According to the mounting structure of this example, it is possible to achieve the same advantages as the fourth example. In addition, because the grooves 49 are formed in the outer circumferential surface 45 of the outer case 42, the safety cover 50 is not necessary to change its design, and therefore, the safety cover 50 can be molded by using an existing molding die.

### Ninth Example

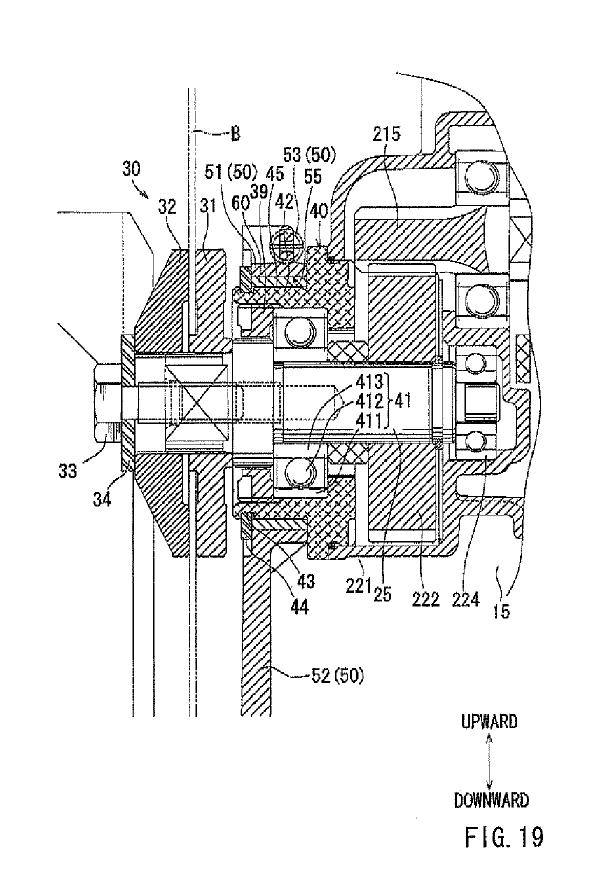

A ninth example will now be described with reference to FIGS. 19 and 21, which show a mounting structure for mounting the safety cover 50 of this example. Also in this example, like members are given the same reference numeral as the first example and the description of these members will not be repeated.

Referring to FIG. 19, according to the ninth example, a slide ring 60 is disposed between the bearing box 40 and the safety cover 50 as an intermediate member for contacting with both of the bearing box 40 and the safety cover 50. More specifically, in this example, the slide ring 60 is disposed between the case 42 of the bearing box 40 and the tubular fitting portion 51 of the safety cover 50, so that the tubular fitting portion 51 of the safety cover 50 can rotate relative to the case 42 of the bearing box 40 with the intervention of the slide ring 60. Thus, in the mounting structure of this example, the outer circumferential surface 45 of the outer case 42, an inner circumferential surface 61 of the slide ring 60, an outer circumferential surface 62 of the slide ring 60, and the inner circumferential surface 55 of the tubular fitting portion 51 serve as slide contact surfaces that slidably contact with their mating slide contact surfaces as the tubular fitting portion 51 rotates relative to the outer case 42.

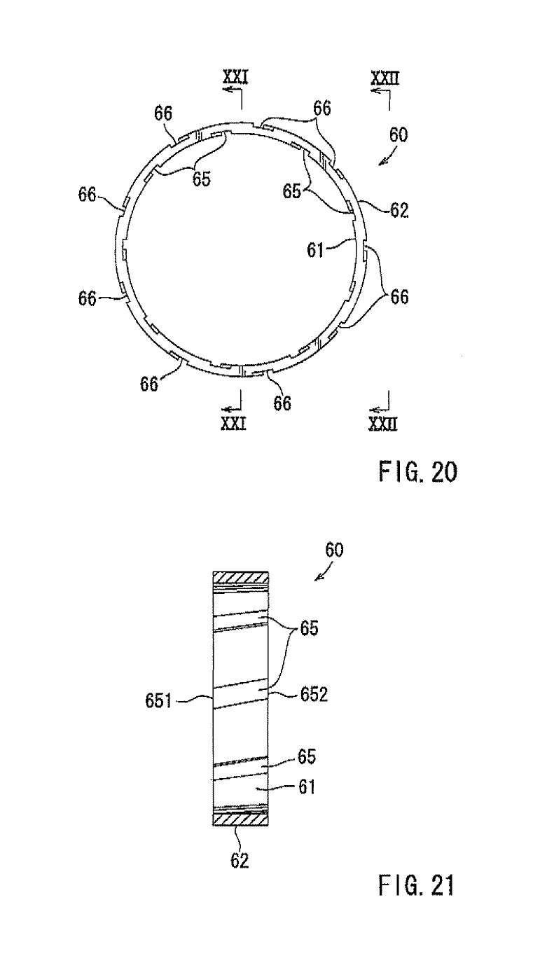

Referring to FIG. 20, the slide ring 60 is a ring-shaped product molded by resin and is fitted between the outer case 42 and the tubular fitting portion 51. Therefore, the slide ring 60 can rotate relative to both of the outer case 42 and the tubular fitting portion 51. In some cases, the slide ring 60 may rotate with the outer case 42 or the tubular fitting portion 51 due to the frictional force.

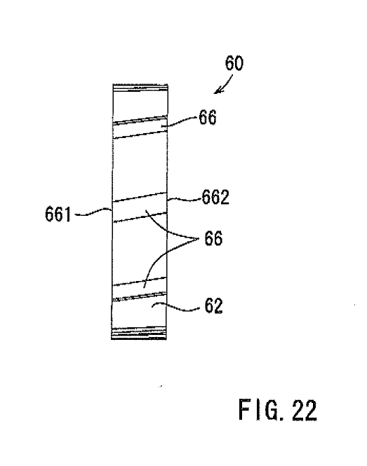

As shown in FIGS. 21 and 22, the inner circumferential surface 61 and the outer circumferential surface 62 serving as slide contact surfaces of the slide ring 60 are provided with inner circumferential grooves 65 and outer circumferential grooves 66 formed therein, respectively. The inner circumferential grooves 65 and the outer circumferential grooves 66 are configured to be similar to the grooves 57 of the second example and the grooves 47 of the sixth example, respectively. Thus, the grooves 65 and 66 are inclined relative to a direction perpendicularly intersecting with the sliding direction (i.e., the circumferential direction) and also inclined relative to the rotational axis of the tubular fitting portion 51. More specifically, the grooves 65 and 66 are inclined downwardly from the side of the drive device 21 toward the rotary cuffing blade B as viewed in a horizontal side view shown in FIGS. 21 and 22. In addition, opposite ends 651 and 652 of each groove 65 and opposite ends 661 and 662 of each groove 66 are opened to the outside.

Also in this example, cutting powder or chips entering between the outer circumferential surface 45 of the outer case 42, the slide ring 60, and the inner circumferential surface 55 of the tubular fitting portion 51 may move into the grooves 65 and 66 as the tubular portion 51 rotates relative to the outer case 42. In addition, the width and the depth of the grooves 65 and those of the grooves 66 are so determined as to be suitable for receiving the cutting powder or chips and not to impair the smooth rotation of the tubular fitting portion 51.

According to the mounting structure of this example, it is possible to achieve the same advantages as the first example. In addition, because the grooves 65 and 66 are formed in the slide ring 60 that is a separate member from the safety cover 50 and the bearing box 40, it is possible to effectively adjust the slidability of the tubular fitting portion 51 relative to the outer case 42. Further, the grooves 65 and 66 can be easily formed in the slide ring 60.

### OTHER POSSIBLE EXAMPLES

The above examples may be modified in various ways. For example, although the mounting structures of the above examples are applied to the hand-held cutting tool 10 configured as a circular saw, they can be also applied to any other cuffing tools, such as a table cutting tool having a table supporting a saw unit, and a slide-type table cutting tool.

In addition, although the grooves (46, 47, 48, 49, 56, 57, 58, 59, 65 and 66) in the above examples are formed in one of two slide contact surfaces that slidably contact with each other as the safety cover 50 (serving as a movable cover) rotates relative to the bearing box 40 (serving as a rotary support member). However, the grooves may be formed in both of the two slide contact surfaces. For example, the second example and the sixth example may be combined so that the grooves 57 are formed in the inner circumferential surface 55 of the tubular fitting portion 51 and the grooves 47 are formed in the outer circumferential surface 45 of the outer case 42. In other words, the above examples may be combined in various ways. In the case of the ninth example incorporating the slide ring 60, all of the outer circumferential surface 45 of the outer case 42, the inner circumferential surface 61 of the slide ring 60, the outer circumferential surface 62 of the slide ring 60, and the inner circumferential surface 55 of the tubular fitting portion 51 may have grooves that are selected from the grooves disclosed in the first to eighth examples.

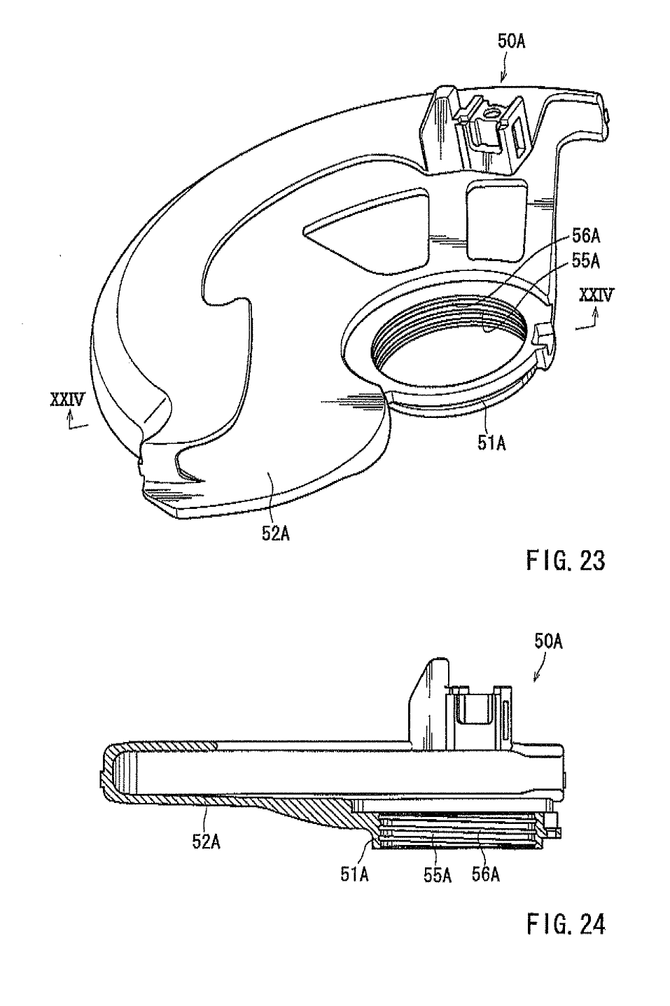

Further, although the grooves formed in the outer circumferential surface 45 of the outer case 42, the inner circumferential surface 55 of the tubular fitting portion 51, the inner circumferential surface 61 of the slide ring 60, or the outer circumferential surface 62 of the slide ring 60 in the above examples are arranged so as to be spaced from each other in the circumferential direction, they may be arranged in a different manner as shown in FIGS. 23 and 24.

Referring to FIGS. 23 and 24, there is shown a safety cover 50A. The safety cover 50A is configured to be basically the same as the safety cover 50 of the above examples and has a tubular fitting portion 51A and a cover body 52A. The tubular fitting potion 51A has an inner circumferential surface 55A that serves as a contact surface for contacting with the outer circumferential surface 45 of the case body 42 of the bearing box 40 as explained in the first example. A spiral groove 56A is formed in the inner circumferential surface 55A of the tubular fitting portion 51A and corresponds to the grooves of the above examples. Thus, the spiral groove 56A has a plurality of groove portions that are inclined relative to a direction perpendicularly intersecting with the sliding direction (i.e., the circumferential direction) of the inner circumferential surface 55A of the tubular fitting portion 51A and also inclined relative to the rotational axis of the tubular fitting portion MA. The groove portions are connected in series with each other to from the spiral groove 56A. In addition, the spiral groove 56A has opposite ends opened to the outside.

Also with this arrangement, cutting powder or chips entering between the outer circumferential surface 45 of the outer case 42 and the inner circumferential surface 55A of the tubular fitting portion 51A may move into the spiral groove 56A as the tubular portion 51A rotates relative to the outer case 42. In addition, the width and the depth of the spiral groove 65A are so determined as to be suitable for receiving the cutting powder or chips and not to impair the smooth rotation of the tubular fitting portion 51A.

Spiral grooves similar to the spiral groove 56A may be used as grooves for the outer circumferential surface 45 of the outer case 42 or the inner circumferential surface 61 or the outer circumferential surface 62 of the slide ring 60.

Further, any other grooves having different configurations from those of the above examples can be used as long as they can receive and discharge cutting powder or chips.

What is claimed is:

1. A cutting tool comprising:
a tool unit having a rotary cutting blade;
a movable cover configured to cover the rotary cutting blade; and
a rotary support member mounted to the tool unit and rotatably supporting the movable cover about a rotational axis, wherein:
the rotary support member has a first contact surface;
the movable cover has a second contact surface slidably contacting the first contact surface, so that the first contact surface and the second contact surface slide relative to each other in a circumferential direction about the rotational axis as the movable cover rotates relative to the rotary support member, and
at least one of the first and second contact surfaces has a groove formed therein.

2. The cutting tool as in claim 1, wherein the groove extends in a direction intersecting with the circumferential direction.

3. The cutting tool as in claim 2, wherein the direction intersecting with the circumferential direction is parallel to the rotational axis.

4. The cutting tool as in claim 2, wherein the direction intersecting with the circumferential direction is inclined relative to the rotational axis.

5. The cutting tool as in claim 1, wherein the groove has opposite ends positioned on opposite sides with respect to a direction along the rotational axis, at least one of the opposite ends being opened in an axial direction of the rotational axis.

6. The cutting tool as in claim 5, wherein the groove has a width in the circumferential direction about the rotational axis and has a length in the direction parallel to the rotational axis, the width gradually increasing in a direction from one of the opposite ends to the other of the opposite ends.

7. The cutting tool as in claim 5, wherein the groove has a width in the circumferential direction about the rotational axis and has a length in the direction parallel to the rotational axis, the width gradually increasing from an intermediate portion along the length to the opposite ends.

8. The cutting tool as in claim 1, wherein the groove comprises a plurality of grooves spaced from each other in the circumferential direction about the rotational axis.

9. The cutting tool as in claim 1, wherein the groove is a spiral groove.

10. The cutting tool as in claim 1, wherein the groove is configured to receive cutting powder or chips produced by the rotary cutting blade during a cutting operation and entering between the first and second contact surfaces and to allow the cutting powder or chips to be discharged from the groove as the movable cover rotates relative to the rotary support member.

11. A cutting tool comprising:
a tool unit having a rotary cutting blade;
a movable cover configured to cover the rotary cutting blade;
a rotary support member mounted to the tool unit and rotatably supporting the movable cover about a rotational axis, and
an intermediate member interposed between the rotary support member and the movable cover, wherein:
the rotary support member has a first contact surface;
the movable cover has a second contact surface;
the intermediate member has a third contact surface and a fourth contact surface slidably contacting the first contact surface and the second contact surface, respectively, so that the first contact surface and the third contact surface slide relative to each other in a circumferential direction about the rotational axis and/or the second contact surface and the fourth contact surface slide relative to each other in the circumferential direction as the movable cover rotates relative to the rotary support member; and
at least one of the first, second, third and fourth surfaces has a groove formed therein.

12. The cutting tool as in claim 11, wherein the groove extends in a direction intersecting with the circumferential direction.

13. The cutting tool as in claim 12, wherein the direction intersecting with the circumferential direction is parallel to the rotational axis.

14. The cutting tool as in claim 12, wherein the direction intersecting with the circumferential direction is inclined relative to the rotational axis.

15. The cutting tool as in claim 11, wherein the groove has opposite ends positioned on opposite sides with respect to a direction along the rotational axis, at least one of the opposite ends being opened to the outside in an axial direction of the rotational axis.

16. The cutting tool as in claim 15, wherein the groove has a width in the circumferential direction about the rotational axis and has a length in the direction parallel to the rotational axis, the width gradually increasing in a direction from one of the opposite ends to the other of the opposite ends.

17. The cutting tool as in claim 15, wherein the groove has a width in the circumferential direction about the rotational axis and has a length in the direction parallel to the rotational axis, the width gradually increasing from an intermediate portion along the length to the opposite ends.

18. The cutting tool as in claim 11, wherein the groove comprises a plurality of grooves spaced from each other in the circumferential direction about the rotational axis.

19. The cutting tool as in claim 11, wherein the groove is a spiral groove.

20. The cutting tool as in claim 11, wherein the groove is configured to receive cutting powder or chips produced by the rotary cutting blade during a cutting operation and entering between the first and third contact surfaces or between the second and fourth contact surfaces and to allow the cutting powder or chips to be discharged from the groove as the movable cover rotates relative to the rotary support member.
